(19) United States
(12) Patent Application Publication
(10) Pub. No.: US 2026/0286145 A1
(43) Pub. Date: Sep. 24, 2026

(54) COMPOSITION FOR THE PREPARATION OF A CATHODE PRIMING COAT

(71) Applicant: COATEX, Genay (FR)

(72) Inventors: Benoît MAGNY, Fontaines Saint Martin (FR); Guillaume MICHAUD, Lyon (FR); Gaël ROBIN, Sathonay-Camp (FR); Jean-Marc SUAU, Lucenay (FR)

(73) Assignee: COATEX, Genay (FR)

(21) Appl. No.: 19/480,076

(22) PCT Filed: Apr. 16, 2024
(86) PCT No.: PCT/FR2024/000051

§ 371 Date: Oct. 30, 2025

(30) Foreign Application Priority Data
May 4, 2023 (FR) 2304466

(51) Int. Cl. C09D 5/24; C09D 5/00; C09D 7/61; C09D 127/16; C09D 133/02; C09D 133/06; H01M 4/02; H01M 4/04; H01M 4/1391; H01M 4/62; H01M 4/66

(52) U.S. Cl. CPC C09D 5/24; C09D 5/002; C09D 7/61; C09D 127/16; C09D 133/02; C09D 133/064; H01M 4/0404; H01M 4/0435; H01M 4/1391; H01M 4/623; H01M 4/625; H01M 4/661; H01M 2004/028

(57) ABSTRACT

A composition for preparing a cathode priming coat, a cathode including the priming coat, and a method of forming the cathode including the priming coat. The priming coat composition includes a polyacrylic binder having a low molecular weight, and carbon particles. The cathode can be used for manufacturing cells for a rechargeable battery.

The invention relates to a composition for preparing a cathode primer coating comprising a polyacrylic binding agent with a low molecular mass and carbon particles. The invention also relates to the use of this composition for preparing a cathode as well as the cathode that can be used to manufacture cells for secondary batteries.

There are known cathode preparation compositions that generally comprise carbon and a metal in the form of particles combined with a binding composition. Binding compositions make it possible to set the particles on a metallic substrate. The binding property is therefore decisive when manufacturing a cathode using these compositions.

The time and yield required to manufacture cathodes are also important factors. It is therefore important to improve the efficacy of the various reactions involved.

As ingredients that are electrochemically inactive during cathode operation, binding compounds do not contribute directly to the capacity of the battery cell comprising the cathode, but their influence on the overall electrochemical performance remains considerable. These binding compounds should help form stable networks of the active or conducting solid compounds present in the cathodes.

The binding compounds used when preparing a cathode should also make it possible to improve thermal stability, chemical and electrochemical stability and tensile strength, in particular through good adhesion and good cohesion, as well as a certain degree of flexibility.

Moreover, the compatibility of the various ingredients of cathode and battery preparation compositions is also an important factor to consider when preparing these compositions as well as when preparing cathodes using these compositions. In particular, compatibility, and particularly the absence of solubility or low solubility, with the electrolyte in the battery is an essential property.

Easy, uniform application of cathode preparation compositions is desirable in order to obtain a uniform coat and to limit or avoid flaws on the surface of the electrode, resulting in a uniform and particularly effective conductive coat. Surface levelling, restructuring and flow behaviour of cathode preparation compositions must be well controlled.

Cathode preparation compositions must also be stable and homogenous during their preparation, storage or application. Settling, cluster or aggregate formation and ingredient separation must therefore be limited or avoided.

In general, improving the adhesion of the active elements should always be sought when preparing the cathode. The adhesion of the different coats of ingredients deposited on the metallic substrate must therefore be improved. In particular, when a primer coating comprising carbon is deposited on the metallic substrate, improving its adhesion is essential. Because they are in direct contact with the metallic cathode substrate and with the binding composition of the electroactive compound, the properties of primer coating compositions are particularly important.

Document CN 106876716 describes the preparation of a cathode by applying a carbon coating using a composition comprising a binding polymer in an organic solvent such as N-methyl-pyrrolidone. Documents CN 115911388 and KR 20110111236 describe methods for preparing cathode coatings using carbon fixed by means of a cross-linking binder in an acid medium or by a cross-linking agent with an oxazoline group. Document CN 115881966 describes a conductive adhesive formulation consisting of polymer compositions grafted using conductive monomers.

The commonly-used compositions for preparing cathode primer coating in the prior art are not always satisfactory. There is thus a need for compositions for use when preparing cathode primer coating that provide solutions to all or part of the problems of the compositions in the prior art.

The invention thus provides an aqueous cathode primer coating preparation composition T comprising:
at least one binding agent R comprising at least one water-soluble polymer P, with a molecular mass Mw, measured by SEC, ranging from 2,000 g/mol to less than 100,000 g/mol, prepared by a polymerisation reaction, in the presence of at least one initiator compound, of at least one compound (a) chosen among acrylic acid, methacrylic acid, an acrylic acid oligomer, a methacrylic acid oligomer, an acrylic acid salt, a methacrylic acid salt, an acrylic acid oligomer salt, a methacrylic acid oligomer salt and combinations thereof,
at least one material E comprising carbon particles.

The invention thus provides a composition for preparing a cathode primer coating. Preferably, the primer coating obtained according to the invention comprises no silicon or electroactive metallic compound.

The polymer P used according to the invention is a water-soluble polymer. Preferably according to the invention, polymer P is water-soluble at a pH greater than 4.

Preferably according to the invention, compound (a) is chosen among acrylic acid, methacrylic acid, an acrylic acid salt, a methacrylic acid salt and combinations thereof; preferably compound (a) is acrylic acid or methacrylic acid.

The polymer P according to the invention can be a homopolymer of compound (a). Polymer P can also be a copolymer of compounds (a) or a copolymer of at least one compound (a) and of at least one other compound (b).

Preferably according to the invention, compound (b) is chosen among:
a compound (b1) chosen among C₁-C₁₂ methacrylic acid esters, C₁-C₁₂ acrylic acid esters and combinations thereof, preferably C₁-C₈ methacrylic acid esters, C₁-C₈ acrylic acid esters and combinations thereof, preferably methyl methacrylate, ethyl methacrylate, propyl methacrylate, butyl methacrylate, methyl acrylate, ethyl acrylate, propyl acrylate, butyl acrylate, more preferentially, methyl acrylate, ethyl acrylate, butyl acrylate;
a compound (b2) chosen among acrylonitrile, acrylamide, N-methylolacrylamide, vinyl lactam, N-vinylpyrrolidone, ureido methacrylate and combinations thereof, preferably acrylonitrile;
a compound (b3) chosen among maleic acid, maleic anhydride, itaconic acid, crotonic acid and combinations thereof;
a compound (b4) chosen among hydroxyethyl acrylate, hydroxyethyl methacrylate, hydroxypropyl acrylate, hydroxypropyl methacrylate, hydroxybutyl methacrylate, caprolactone methacrylate, caprolactone acrylate, polycaprolactone methacrylate, polycaprolactone acrylate, lactam methacrylate, lactam acrylate, polycaprolactam methacrylate, polycaprolactam acrylate, styrene, more preferentially styrene;
a compound (b5) chosen among 2-acrylamido-2-methylpropane sulphonic acid, a 2-acrylamido-2-methylpropane sulphonic acid salt, ethoxy methacrylate sulphonic acid, sodium methallyl sulphonate, styrene sulphonate, hydroxyethyl acrylate phosphate, hydroxyethyl methacrylate phosphate, hydroxypropyl acrylate phosphate, hydroxypropyl methacrylate phosphate, hydroxybutyl methacrylate phosphate;
a cross-linking compound (b6).

According to the invention, polymer P can only be prepared by a polymerisation reaction of monomer (a) and optionally of at least one compound (b) chosen among compounds (b1) to (b6).

Preferably according to the invention, polymer P is not cross-linked, in particular using calcium acetate, calcium hydroxide, calcium bicarbonate or calcium oxalate or using a compound comprising an oxazoline group. Also preferably, compound (b) is not acrylonitrile or acrylamide or it comprises no fluorine; polymer P is thus not a fluorinated polymer. Also preferably according to the invention, polymer P is a free polymer, it is not grafted, in particular it is not grafted to a fluorinated polymer or it is not grafted to a polyaniline, a polypyrrole, a polythiophene, a polyparaphenylene or to a polyphenylacetylene.

According to the invention, polymer P1 is not a conductive polymer.

The amounts of monomers present in polymer P can vary relatively widely. Preferably for the composition T according to the invention, polymer P is prepared by a polymerisation reaction of from 55% by weight to 100% by weight of compound (a) and from 0% by weight to 45% by weight of compound (b). Also preferably, polymer P can be prepared by a polymerisation reaction of from 55% by weight to 90% by weight of compound (a) and from 10% by weight to 45% by weight of compound (b) or from 55% by weight to 80% by weight of compound (a) and from 20% by weight to 45% by weight of compound (b). Polymer P can also be prepared by a polymerisation reaction of from 55% by weight to 70% by weight of compound (a) and from 30% by weight to 45% by weight of compound (b).

Essentially according to the invention, polymer P has a molecular mass Mw, measured by SEC, of less than 100,000 g/mol, preferably strictly less than 100,000 g/mol. Preferably, polymer P has a molecular mass Mw, measured by SEC, of less than 80,000 g/mol or less than 50,000 g/mol.

Also preferably according to the invention, polymer P has a molecular mass Mw, measured by SEC, ranging from 2,000 g/mol to 80,000 g/mol or from 2,000 g/mol to 50,000 g/mol. More preferably, the molecular mass Mw of polymer P ranges from 2,000 g/mol to 40,000 g/mol or from 2,000 g/mol to 30,000 g/mol. More preferentially, it ranges from 2,000 g/mol to 25,000 g/mol or from 2,000 g/mol to 20,000 g/mol or from 5,000 g/mol to 25,000 g/mol or from 5,000 g/mol to 20,000 g/mol. Much more preferentially, it ranges from 8,500 g/mol to 25,000 g/mol or from 8,500 g/mol to 20,000 g/mol or from 9,000 g/mol to 25,000 g/mol or from 9,000 g/mol to 20,000 g/mol.

According to the invention, the molecular weight or mass of the polymer P is determined by Size Exclusion Chromatography (SEC). A test portion of the polymer solution corresponding to 90 mg of dry solids content is placed into a 10 mL flask. Mobile phase is added, together with 0.04% of dimethylformamide (DMF), until a total mass of 10 g is reached. The composition of this mobile phase is as follows: NaHCO₃:0.05 mol/L, NaNO3:0.1 mol/L, triethanolamine: 0.02 mol/L, NaN₃ 0.03% by mass. The SEC chain is composed of a Waters 510 isocratic pump with a flow rate set to 0.8 mL/min, a Waters 717+ sample changer, an oven containing a Waters Ultrahydrogel Column Guard precolumn 6 cm long and 40 mm in inner diameter, followed by a Waters Ultrahydrogel linear column 30 cm long and 7.8 mm in inner diameter. Detection is provided by means of a Waters 410 RI differential refractometer. The oven is brought to a temperature of 60° C. and the refractometer is brought to a temperature of 45° C. The SEC instrument is calibrated with a series of polyacrylate sodium standards supplied by Polymer Standards Service with a molecular weight at the top of the peak comprised between 1,000 g/mol and 1.106 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using “PSS WinGPC Scientific” software v 4.02. The chromatogram obtained is incorporated into the area corresponding to molecular weights of more than 250 g/mol. Also preferably according to the invention, polymer P has a glass transition temperature Tg, calculated using the Flory-Fox equation, ranging from −10° C. to 230° C. or from 20° C. to 230° C. More preferably according to the invention, polymer P is a homopolymer with a Tg greater than 0° C., preferably greater than 10° C.

Also more preferably according to the invention, polymer P is a copolymer with a Tg greater than 50° C., preferably greater than 100° C. The Flory-Fox equation is used to calculate the glass transition temperature of a copolymer based on the parameters of the monomers used in its preparation.

The polymer P used according to the invention can be used in its acid form or in a form in which all or some of its carboxyl groups can be neutralised. Preferably according to the invention, polymer P is therefore completely or partially acidic or completely or partially non-neutralised. More preferentially, polymer P is partially neutralised. According to the invention, polymer P is preferentially neutralised using at least one compound chosen among LiOH, NaOH, KOH, Zn(OH)₂, Mg(OH)₂, Ca(OH)₂, ZnO, MgO, CaO, ammonium derivatives, ammoniac, ammonia, amino bases, for example triethanolamine, aminomethyl propanol or 2-amino-2-methyl propanol (AMP) and combinations thereof, much more preferentially LiOH or Zn(OH)₂ or ZnO.

According to the invention, polymer P is prepared by a polymerisation reaction at a temperature greater than 50° C., preferably at a temperature ranging from 60° C. to 95° C. or ranging from 65° C. to 90° C., in particular at a temperature ranging from 70° C. to 85° C. Preferably, the initiator compound is chosen among peroxides, hydroperoxides, persulphates and combinations thereof. More preferably according to the invention, the initiator compound is chosen among hydrogen peroxide, tert-butyl hydroperoxide, benzoyl peroxide, acetyl peroxide, lauryl peroxide, tert-butyl hydroperoxide, cumene hydroperoxide, ammonium persulphate, an alkali metal persulphate (in particular sodium persulphate, potassium persulphate), an azo compound and combinations thereof or associations thereof with an ion chosen among Fe^{II}, Fe^{III}, Cu^{I}, Cu^{II} and combinations thereof. According to the invention, the initiator compound can also be an organic compound, preferably an organic initiator compound chosen among compounds with an azo group, preferably chosen among 4,4′-azobis(4-cyanovaleric) acid (CAS No. 2638-94-0), 2,2′-azobis(2-methylpropionamidine) dihydrochloride (CAS No. 2997-92-4), azo-bis-isobutyronitrile (AZDN or AIBN) and combinations thereof.

Within the composition T according to the invention, the ingredients can be present in amounts that can vary quite widely. Preferably according to the invention, the composition T according to the invention comprises, by dry weight:
from 0.5% to 70% of binding agent R,
from 30% to 99.5% of material E,
   relative to the total amount by dry weight of binding agent R and of material E.

Advantageously according to the invention, binding agent R comprises at least one polymer P and at least one liquid substrate, preferably water, alone or combined with at least one polar solvent, for example a solvent chosen among ethanol, isopropanol and combinations thereof. Also preferentially according to the invention, binding agent R comprises:
from 5% by weight to 60% by weight of polymer P and
from 40% by weight to 95% by weight of liquid substrate, more preferentially
from 10% by weight to 40% by weight of polymer P and
from 60% by weight to 90% by weight of liquid substrate.

Preferably according to the invention, composition T comprises water, alone or combined with at least one polar solvent, for example a solvent chosen among ethanol, isopropanol and combinations thereof. More preferably according to the invention, composition T comprises no polar solvent or comprises no solvent chosen among ethanol, isopropanol and combinations thereof, in particular no isopropanol.

Essentially according to the invention, in addition to polymer P, composition T according to the invention comprises a material E that comprises carbon particles. Preferably according to the invention, material E is chosen among carbon black, acetylene black, Ketjen black, carbon fibres, carbon nanotubes, carbon nanofibres, hard carbon and combinations thereof.

The use of the composition T according to the invention is particularly advantageous for manufacturing a cathode. The invention thus also provides a method for preparing a cathode comprising:
applying at least one aqueous composition T according to the invention to a metallic substrate comprising at least one metal chosen among aluminium, nickel, preferably aluminium;
drying then optionally calendering the metallic substrate carrying the primer coating; then
applying an electroactive composition comprising at least one electroactive compound, at least one binding compound of the electroactive compound and at least one organic solvent;
drying then calendering the metallic substrate carrying the primer coating and the electroactive coating.

Preferably according to the invention, the substrate is a purely metallic substrate or a composite substrate comprising at least one metal and at least one insulating substrate.

Also preferably according to the invention, the electroactive compound comprises at least one metal chosen among lithium, iron, nickel, manganese, cobalt and combinations thereof.

Also preferably according to the invention, the electroactive compound is in the form of a metal salt, preferably a polymetallic salt, more preferentially the electroactive compound is chosen among LiFePO₄ (LFP), Li(Ni,Mn,Co)O₂ (NMC) and combinations thereof.

Preferably according to the invention, the binding compound of the electroactive compound is polyvinylidene fluoride (PVDF). Preferentially according to the invention, the binding compound of the electroactive compound is not a (meth)acrylic polymer.

Preferably according to the invention, the organic solvent is an aprotic polar solvent, preferably chosen among pyrrolidone, N-methyl-pyrrolidone (NMP), alkyl carbonates and combinations thereof.

Preferably according to the invention, the electroactive composition comprises carbon, preferably chosen among carbon black, acetylene black, Ketjen black, carbon fibres, carbon nanotubes, carbon nanofibres, hard carbon and combinations thereof.

The invention also provides a cathode comprising at least one metallic substrate coated with at least one primer coating comprising a binding agent R and at least one material E according to the invention, preferably obtained according to the preparation method according to the invention.

The invention also provides a cathode produced according to the preparation method according to the invention.

The polymer P of the binding agent R of the composition T according to the invention has particularly advantageous properties for the preparation of a cathode primer coating and therefore for obtaining a cathode. In particular, the polymer P used according to the invention improves adhesion to the metallic substrate of the cathode. In particular, the polymer P used according to the invention improves adhesion to the metallic substrate when used in combination with the binding compound of the electroactive compound. The compatibility of the polymer P used according to the invention and of the binding compound of the electroactive compound is particularly advantageous when preparing a cathode.

The invention thus provides a method for improving the adhesion to a metallic cathode substrate comprising at least one metal chosen among aluminium and nickel, of an electroactive composition comprising at least one electroactive compound, at least one binding compound of the electroactive compound and at least one organic solvent. Preferably, this method of improving adhesion to a metallic cathode substrate comprises:
pre-applying directly on the metallic substrate, then drying and optionally calendering, at least one aqueous composition T for preparing a primer coating according to the invention, then
applying the electroactive composition,
drying then calendering the metallic substrate carrying the primer coating and the electroactive coating.

The polymer P used according to the invention improves subsequent adhesion with the binding compound of the electroactive compound. It acts as an adhesion promoter between the metallic substrate and this binding compound of the electroactive compound. It also contributes to the adhesion of the carbon particles of material E to the metallic substrate.

The advantageous, particular or preferred characteristics of the composition T according to the invention define methods for preparing a cathode according to the invention, methods for improving adhesion to a metallic cathode substrate, and cathodes, that are also advantageous, particular or preferred.

The various aspects of the invention can be illustrated by examples.

### EXAMPLES

Preparation and characterisation of polymers P and agents R according to the invention:

### Polymer P1 and Agent R1

200 g of isopropanol and 1.7 g of 2,2′-azobis-(2-methylpropionitrile) (AZDN) are weighed into a 1 L reactor equipped with mechanical stirring, oil bath heating and peristaltic pumps. The mixture is then heated under reflux to about 80° C. and 200 g of acrylic acid and 81 g of butyl acrylate are added in 120 minutes using the peristaltic pumps. Heating is then continued under reflux for 60 minutes. The isopropanol is then distilled and it is gradually replaced with water during distillation. The mixture is then cooled, then diluted to obtain agent R1 according to the invention, which has a dry solids content of 40% by weight, a pH of 2.3 and which comprises polymer P1 with a molecular mass Mw, measured by SEC, of 9,000 g/mol.

### Polymer P2 and Agent R2

200 g of isopropanol and 1.7 g of AZDN are weighed into a 1 L reactor equipped with mechanical stirring, oil bath heating and peristaltic pumps. The mixture is then heated under reflux to around 80° C. and 200 g of acrylic acid and 80 g of ethyl acrylate are added in 120 minutes using the peristaltic pumps. Heating is then continued under reflux for 60 minutes. The isopropanol is then distilled and it is gradually replaced with water during distillation. The mixture is then cooled, then diluted to obtain agent R2 according to the invention, which has a dry solids content of 40% by weight, a pH of 2.2 and which comprises polymer P2 with a molecular mass Mw, measured by SEC, of 9,500 g/mol.

### Polymer P3 and Agent R3

200 g of isopropanol and 1.9 g of AZDN are weighed into a 1 L reactor equipped with mechanical stirring, oil bath heating and peristaltic pumps. The mixture is then heated under reflux to around 80° C. and 200 g of acrylic acid and 83 g of methyl methacrylate are added in 120 minutes using the peristaltic pumps. Heating is then continued under reflux for 60 minutes. The isopropanol is then distilled and it is gradually replaced with water during distillation. The mixture is then cooled, diluted to obtain agent R3 according to the invention, which has a dry solids content of 40% by weight, a pH of 2.5 and which comprises polymer P3 with a molecular mass Mw, measured by SEC, of 8,000 g/mol.

### Polymer P4 and Agent R4

209.7 g of water, 0.08 g of iron sulphate heptahydrate and 0.011 g of copper sulphate pentahydrate are weighed into a 1 L reactor equipped with mechanical stirring, oil bath heating and peristaltic pumps. The mixture is then heated to 95° C. and, using the peristaltic pumps, 302.5 g of acrylic acid, 13 g of water, 25.6 g of sodium hypophosphite monohydrate dissolved in 29 g of water and 20.46 g of hydrogen peroxide 130V diluted in 25 g of water are added in 120 minutes. Heating is then continued under reflux for 60 minutes. The mixture is then cooled, and diluted to obtain agent R4 according to the invention, which has a dry solids content of 40% by weight, a pH of 2.1 and which comprises polymer P4 with a molecular mass Mw, measured by SEC, of 4,400 g/mol.

### Polymer P5 and Agent R5

121 g of water, 121 g of isopropanol, 0.06 g of iron sulphate heptahydrate and 11 g of hydrazine hydrate at 35% concentration in water are weighed into a 1 L reactor equipped with mechanical stirring, oil bath heating and peristaltic pumps. The mixture is then heated under reflux to around 80° C. and the following are added in 120 minutes using the peristaltic pumps:
in a first test sample, 174 g of acrylic acid, 35 g of methyl methacrylate, 110 g of ethylene glycol phosphate and 80 g of water,
in a second test sample, 20 g of 130V hydrogen peroxide and 100 g of water.

Heating is then continued under reflux for 60 minutes.

The isopropanol is then distilled and it is gradually replaced with water during distillation. The mixture is then cooled, diluted to obtain agent R5 according to the invention, which has a dry solids content of 40% by weight, a pH of 2.0 and which comprises polymer P5 with a molecular mass Mw, measured by SEC, of 15,000 g/mol.

### Preparation of Aqueous Compositions T1 to T5 for Preparing a Cathode Primer Coating According to the Invention

150 g of deionised water are weighed with 25 g of agent R1 according to the invention, then mixed under stirring using a dispersing instrument (VMI) fitted with a toothed blade 6.5 cm in diameter. Then 10 g of carbon black (Imerys C-Nergy Super C65) are added while continuing to stir for 1.25 hours at 1,500 rpm to obtain a composition which is checked for homogeneity and absence of aggregates using a North gauge.

Similarly, cathode primer coating compositions T2 to T5 are prepared by replacing agent R1 with agents R2 to R5, respectively.

### Preparation and Characterisation of Cathodes According to the Invention

On an aluminium sheet degreased with acetone, 12 μm of cathode primer coating preparation composition T1 according to the invention are applied using a coater equipped with a threaded rod (RK Control Coater) at an application speed of 10 mm/s. It is then dried in a heat chamber at 150° C. for 5 minutes. The primer coating obtained using composition T1 applied then dried has a mass, measured using a precision balance, of 0.2 mg for an aluminium disc 12 mm in diameter and 10 μm+/−1 μm thick.

Similarly, cathode primer coatings are prepared using compositions T2 to T5.

Adhesion to the aluminium cathode substrate of the primer coating obtained using compositions T1 to T5 according to the invention is assessed using a peel test. A standardised adhesive tape (Intertape 51596 CIC8091013) is manually applied to the cathode primer coating. The adhesive tape is then peeled off and the adhesion of the primer coating to the aluminium is visually assessed.

The compatibility of the primer coating prepared according to the invention with a secondary coat of binding agent is assessed for a polyvinylidene fluoride binding agent (Arkema Kynar HSV900 PVDF) applied in an N-methylpyrrolidone (NMP) solvent medium.

A coat of PVDF binding agent is applied to a cathode primer coating obtained according to the method described above using a 5% concentration solution of PVDF in NMP, then applied as a 9 μm coat and dried in a heat chamber at 150° C. for 5 minutes.

A standardised adhesive tape (Intertape 51596 CIC8091013) is manually applied to the cathode secondary coat. Then the adhesive tape is peeled off and the adhesion is visually assessed.

The results obtained for the adhesion of the primer coating and for its compatibility with the PVDF secondary coat are shown in Table 1 according to the following scale:
1: aluminium sheet visible over most of the surface of the adhesive tape,
2: aluminium sheet visible over part of the surface of the adhesive tape,
3: aluminium sheet not visible on the surface of the adhesive tape,
4: primer coating largely intact,
5: primer coating fully intact.

Assessments 1 and 2 are unacceptable for use of the cathode in a secondary battery. Assessments 3 to 5 are acceptable for use of the cathode in a secondary battery. The results are shown in Table 1.

TABLE 1

| Composition T according | | |
|---|---|---|
| to the invention | Adhesion | Compatibility |
| T1 | 5 | 5 |
| T2 | 3 | 4 |
| T3 | 4 | 5 |
| T4 | 4 | 4 |
| T5 | 5 | 5 |

Binding agents R comprising the polymers according to the invention make it possible to produce primer coatings with good-quality adhesion that hold the conductive carbon on the surface of the aluminium sheet very well. They also act as binding agents compatible with the PVDF secondary binding agent that is the polymeric constituent of the LFP coat, making it possible to increase the adhesion of the LFP coat to the cathode primer coating.

1. A composition for preparing a cathode primer coating, comprising:
a binding agent comprising a water-soluble polymer having a molecular mass Mw, measured by SEC, ranging from 2,000 g/mol to less than 100,000 g/mol, and prepared by a polymerisation reaction of an initiator compound, and a compound (a) which is at least one selected from the group consisting of acrylic acid, methacrylic acid, an acrylic acid oligomer, a methacrylic acid oligomer, an acrylic acid salt, a methacrylic acid salt, an acrylic acid oligomer salt, and a methacrylic acid oligomer salt, and
a carbon-containing material comprising carbon particles.

2. The composition of claim 1, wherein compound (a) is at least one selected from the group consisting of acrylic acid, methacrylic acid, an acrylic acid salt, and a methacrylic acid salt.

3. The composition of claim 1, wherein the water-soluble polymer is
water-soluble at a pH greater than 4;
in which polymer P is a homopolymer of compound (a);
polymer P is a copolymer comprising compound (a); or
polymer P is a copolymer comprising compound (a) and a compound (b), preferably a compound (b) which is at least one selected from the group consisting of a C₁-C₁₂ methacrylic acid ester, a C₁-C₁₂ acrylic acid ester, acrylonitrile, acrylamide, N-methylolacrylamide, vinyl lactam, N-vinylpyrrolidone, ureido methacrylate, maleic acid, maleic anhydride, itaconic acid, crotonic acid, hydroxyethyl acrylate, hydroxyethyl methacrylate, hydroxypropyl acrylate, hydroxypropyl methacrylate, hydroxybutyl methacrylate, styrene, caprolactone methacrylate, caprolactone acrylate, polycaprolactone methacrylate, polycaprolactone acrylate, lactam methacrylate, lactam acrylate, polycaprolactam methacrylate, polycaprolactam acrylate, 2-acrylamido-2-methylpropane sulphonic acid, a 2-acrylamido-2-methylpropane sulphonic acid salt, ethoxy methacrylate sulphonic acid, sodium methallyl sulphonate, styrene sulphonate, hydroxyethyl acrylate phosphate, hydroxyethyl methacrylate phosphate, hydroxypropyl acrylate phosphate, hydroxypropyl methacrylate phosphate, hydroxybutyl methacrylate phosphate, and
a cross-linking compound (b6).

4. The composition of claim 1, wherein the polymer comprises 55% by weight to 100% by weight compound (a) and 0% by weight to 45% by weight compound (b).

5. The composition of claim 1, comprising, by dry weight:
from 0.5% to 70% the binding agent, and
from 30% to 99.5% the carbon-containing material, relative to the each based on a total amount by dry weight of binding agent R and of material E.

6. The composition of claim 1, wherein the polymer has a molecular mass Mw, measured by SEC, ranging from 2,000 g/mol to 80,000 g/mol.

7. The composition of claim 1, wherein the polymer has a glass transition temperature Tg, calculated using the Flory-Fox equation, ranging from −10° C. to 230° C.

8. The composition of claim 1, wherein the polymer is completely or partially acidic or completely or partially non-neutralised.

9. The composition of claim 1, wherein the binding agent comprises
5% to 60% by weight the polymer; and
40 to 95% by weight a liquid substrate, based on a total weight of the binding agent.

10. The composition of claim 1, wherein the carbon-containing material is at least one selected from the group consisting of carbon black, acetylene black, Ketjen black, carbon fibres, carbon nanotubes, carbon nanofibres, and hard carbon.

11. A method for preparing a cathode, the method comprising:
applying the composition of claim 1 to a metallic substrate comprising a metal which is at least one selected from the group consisting of aluminium and nickel to form a metallic substrate carrying a primer coating;
drying the metallic substrate carrying the primer coating;
applying an electroactive composition comprising an electroactive compound, a binding compound of the electroactive compound, and an organic solvent to form a metallic substrate having an primer coating and an electroactive coating, and
drying then calendering the metallic substrate carrying the primer coating and the electroactive coating to form the cathode.

12. The method of claim 11, wherein:
the substrate is at least one selected from the group consisting of a purely metallic substrate and a composite substrate comprising a metal and an insulating substrate,
the electroactive compound comprises at least one metal selected from the group consisting of lithium, iron, nickel, manganese, and cobalt,
the electroactive compound is in the form of a metal salt,
the binding compound of the electroactive compound is polyvinylidene fluoride (PVDF),
the organic solvent is an aprotic polar solvent which is at least one selected from the group consisting of pyrrolidone, N-methyl-pyrrolidone (NMP), and an alkyl carbonate,
the electroactive composition comprises at least one selected from the group consisting of carbon black, acetylene black, Ketjen black, carbon fibres, carbon nanotubes, carbon nanofibres, and hard carbon.

13. A cathode, comprising
a metallic substrate coated with a primer coating comprising the composition of claim 1.

14. (canceled)

15. The composition of claim 3, wherein
the C₁-C₁₂ methacrylic acid ester is at least one selected from the group consisting of methyl methacrylate, ethyl methacrylate, propyl methacrylate, and butyl methacrylate; and
the C₁-C₁₂ acrylic acid ester is at least one selected from the group consisting of methyl acrylate, ethyl acrylate, propyl acrylate, and butyl acrylate.

16. The composition of claim 9, wherein the liquid substrate comprises water.

17. The composition of claim 16, wherein the liquid substrate further comprises at least one selected from the group consisting of ethanol and isopropanol.

18. The method of claim 11, further comprising, following the drying, calendering the metallic substrate carrying the primer coating.

19. The method of claim 12, wherein the electroactive compound is at least one selected from the group consisting of LifePO₄ and Li(Ni,Mn,Co)O₂.
